(19) United States
(12) Patent Application Publication
(10) Pub. No.: US 2016/0183252 A1
(43) Pub. Date: Jun. 23, 2016

(54) IMMEDIATE RESPONSE RESOURCE ALLOCATION WITH MIXED PHY AND MAC SIGNALING

(71) Applicant: QUALCOMM Incorporated, San Diego, CA (US)

(72) Inventors: Simone MERLIN, San Diego, CA (US); Bin TIAN, San Diego, CA (US); George CHERIAN, San Diego, CA (US); Alfred ASTERJADHI, San Diego, CA (US); Gwendolyn Denise BARRIAC, Encinitas, CA (US)

(21) Appl. No.: 14/972,779

(22) Filed: Dec. 17, 2015

Related U.S. Application Data
(60) Provisional application No. 62/094,933, filed on Dec. 19, 2014.

(51) Int. Cl. H04W 72/04

(52) U.S. Cl. CPC H04W 72/0446; H04W 72/042; H04W 72/0413

(57) ABSTRACT

Certain aspects of the present disclosure relate to immediate response resource allocation with physical (PHY) layer and medium access control (MAC) layer signaling. Certain aspects of the present disclosure provide an apparatus for wireless communications. The apparatus generally includes a first interface configured to obtain a first frame having a PHY header and a MAC payload and a processing system configured to determine, based on an indication provided in the PHY header of the first frame, that a response frame to the first frame is to be sent within a time period. This may enable the apparatus to start generating and transmitting an immediate response before decoding the MAC payload.

### CLAIM OF PRIORITY UNDER 35 U.S.C. §119

The present application for patent claims benefit of U.S. Provisional Patent Application Ser. No. 62/094,933 (Attorney Docket number 151157USL), filed Dec. 19, 2014, assigned to the assignee hereof and hereby expressly incorporated by reference herein.

### BACKGROUND

1. Field of the Disclosure

Certain aspects of the present disclosure generally relate to wireless communications and, more particularly, to immediate response resource allocation with physical (PHY) layer and medium access control (MAC) layer signaling.

2. Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure generally relate to immediate response resource allocation with physical (PHY) layer and medium access control (MAC) layer signaling.

Certain aspects of the present disclosure provide an apparatus for wireless communications. The apparatus generally includes a first interface configured to obtain a first frame having a PHY header and a MAC payload and a processing system configured to determine, based on an indication provided in the PHY header of the first frame, that a response frame to the first frame is to be sent within a time period.

Certain aspects of the present disclosure provide another apparatus for wireless communication. The apparatus generally includes a processing system configured to generate a frame having a PHY header and a MAC payload and to provide an indication in the PHY header of the first frame, that a response frame to the first frame is to be sent within a time period and a first interface configured to output the first frame for transmission.

Certain aspects of the present disclosure provide a method for wireless communication. The method generally includes obtaining a first frame having a PHY header and a MAC payload and determining, based on an indication provided in the PHY header of the first frame, that a response frame to the first frame is to be sent within a time period.

Certain aspects of the present disclosure provide another method for wireless communication. The method generally includes generating a first frame having a PHY header and a MAC payload, providing an indication in the PHY header of the first frame, that a response frame to the first frame is to be sent within a time period, and outputting the first frame for transmission.

Certain aspects of the present disclosure provide another apparatus for wireless communication. The apparatus generally includes mean for obtaining a first frame having a PHY header and a MAC payload and means for determining, based on an indication provided in the PHY header of the first frame, that a response frame to the first frame is to be sent within a time period.

Certain aspects of the present disclosure provide another apparatus for wireless communication. The apparatus generally includes means for generating a first frame having a PHY header and a MAC payload, means for providing an indication in the PHY header of the first frame, that a response frame to the first frame is to be sent within a time period, and means for outputting the first frame for transmission.

Certain aspects of the present disclosure provide a computer program product. The computer program product generally includes a computer-readable medium having instructions stored thereon for obtaining a first frame having a PHY header and a MAC payload and determining, based on an indication provided in the PHY header of the first frame, that a response frame to the first frame is to be sent within a time period.

Certain aspects of the present disclosure provide another computer program product. The computer program product generally includes a computer-readable medium having instructions stored thereon for generating a first frame having a PHY header and a MAC payload, providing an indication in the PHY header of the first frame, that a response frame to the first frame is to be sent within a time period, and outputting the first frame for transmission.

Certain aspects of the present disclosure provide a station. The station generally includes at least one antenna, a receiver configured to receive, via the at least one antenna, a first frame having a PHY header and a MAC payload, and a processing system configured to determine, based on an indication provided in the PHY header of the first frame, that a response frame to the first frame is to be sent within a time period.

Certain aspects of the present disclosure provide another station. The station generally includes at least one antenna, a processing system configured to generate a first frame having a PHY header and a MAC payload and to provide an indication in the PHY header of the first frame, that a response frame to the first frame is to be sent within a time period, and a transmitter configured to transmit the first frame via the at least one antenna.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an example uplink (UL) downlink (DL) frame exchange.

FIG. 5 is an example call flow illustrating an UL/DL frame exchange, in accordance with certain aspects of the present disclosure.

FIG. 6 is a flow diagram of example operations for wireless communications, in accordance with certain aspects of the present disclosure.

FIG. 6A illustrates example means capable of performing the operations shown in FIG. 6.

FIG. 7 illustrates example fields of a physical layer (PHY) header, in accordance with certain aspects of the present disclosure.

FIG. 8 is a flow diagram of example operations for wireless communications, in accordance with certain aspects of the present disclosure.

FIG. 8A illustrates example means capable of performing the operations shown in FIG. 8.

FIG. 9 illustrates an example UL/DL single user (SU) frame exchange, in accordance with certain aspects of the present disclosure.

FIG. 10 illustrates an example UL/DL multiple user (MU) frame exchange, in accordance with certain aspects of the present disclosure.

FIG. 11 illustrates an example UL/DL MU frame exchange, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to immediate response resource allocation with physical (PHY) layer and medium access control (MAC) layer signaling. As will be described in more detail herein, certain MAC information may included in the PHY header of a frame to enable a (receiving) station that decodes the PHY header to begin generating and transmitting an immediate response to the frame, in some cases before having decoded the MAC payload of the frame. Enabling a device to respond immediately in this manner (e.g., after a predetermined interframe period), may result in reduced latency and a corresponding increase in overall system performance.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

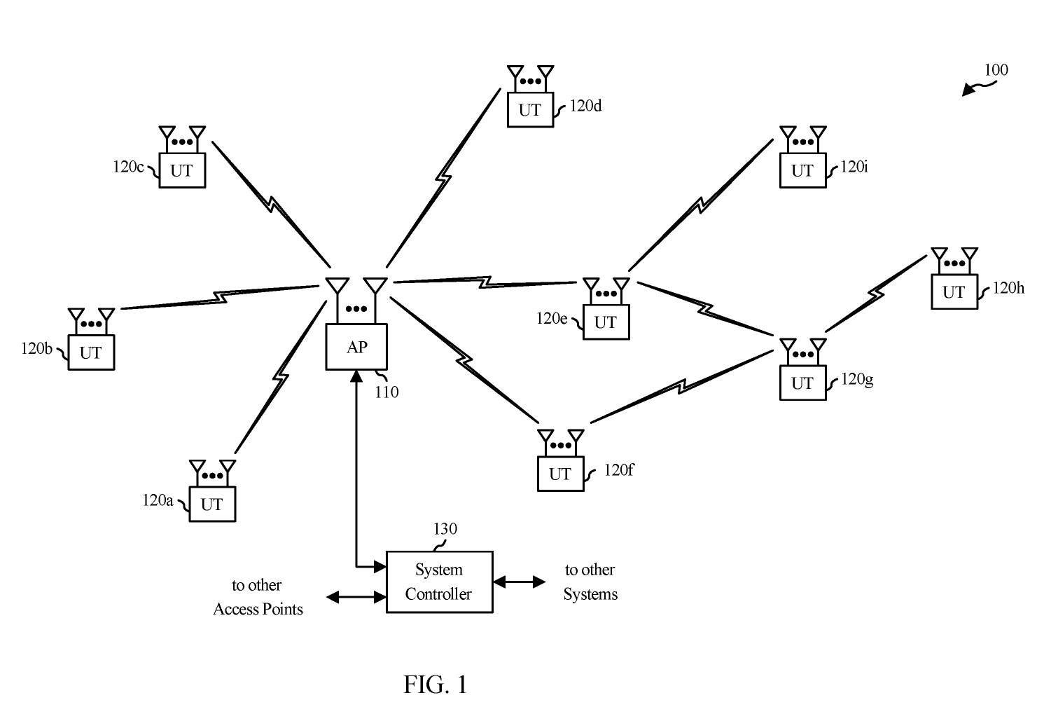

FIG. 1 illustrates a system 100 in which aspects of the disclosure may be performed. For example, the access point 110 may send user terminals 120 a request frame (e.g., a physical layer convergence protocol (PLCP) protocol data unit (PPDU)) having an indication in a physical layer (PHY) header of the request frame that includes an indication that an immediate response is to be sent. Recipient user terminals 120 may determine, based on the indication, that a response is to be sent and may begin generating and transmitting at least a portion of an immediate response, for example, before decoding the medium access control (MAC) payload of the request frame. The response may be considered as an immediate response, for example, if it is to be sent within a given time (e.g., a SIFS period) after receipt of the request frame.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

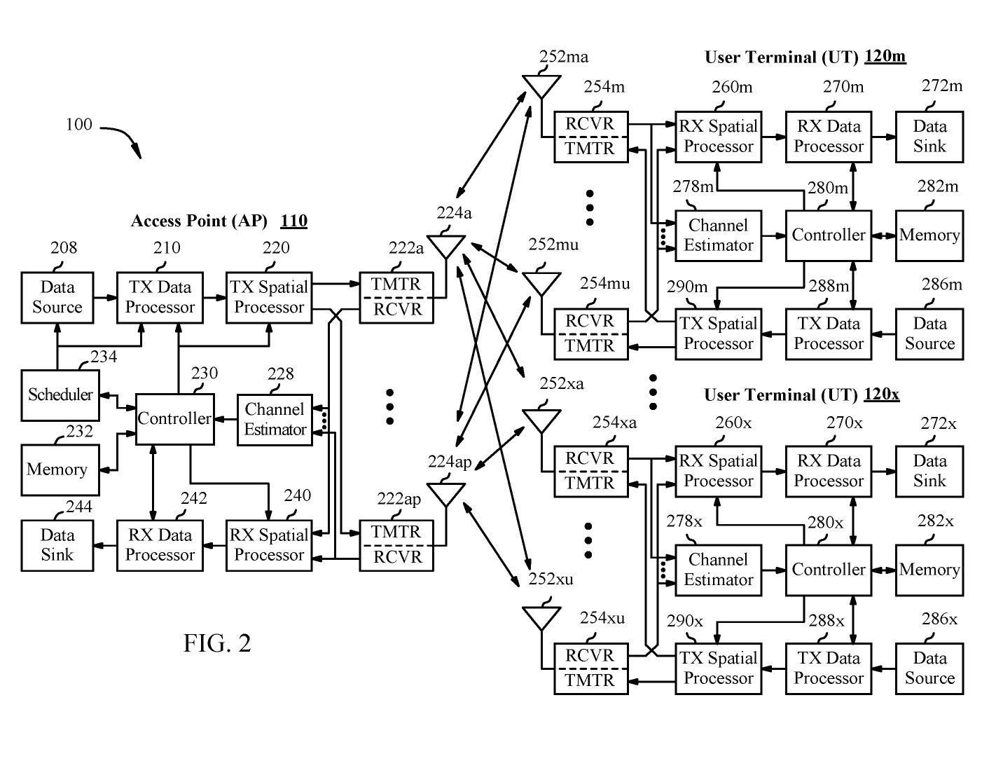

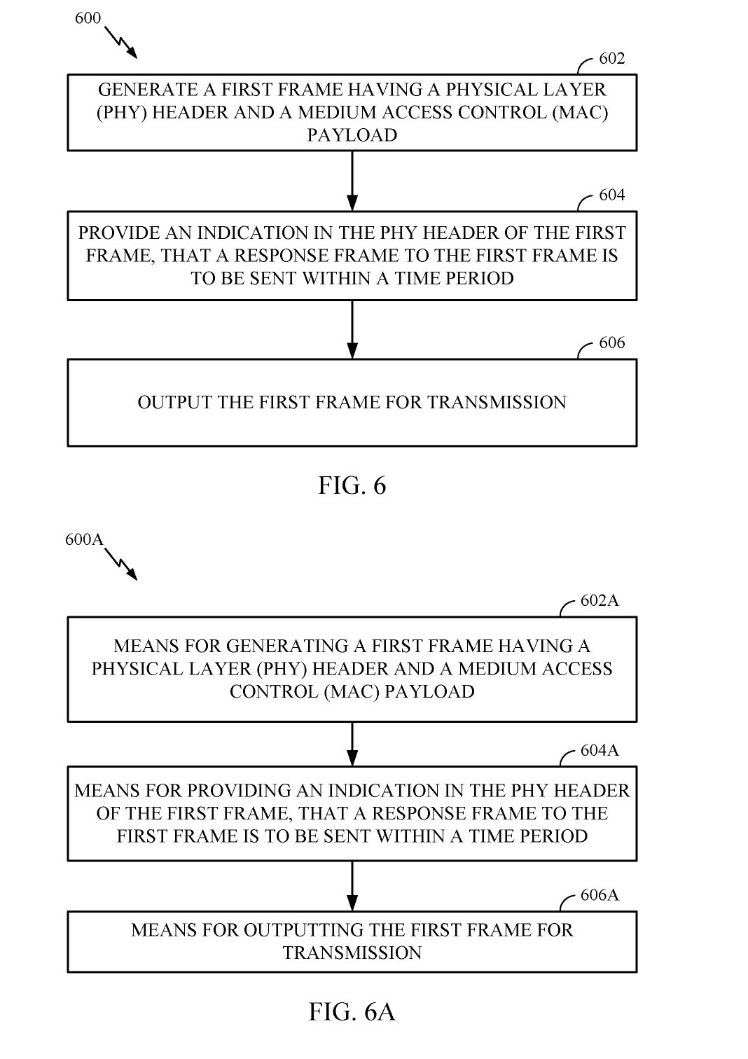

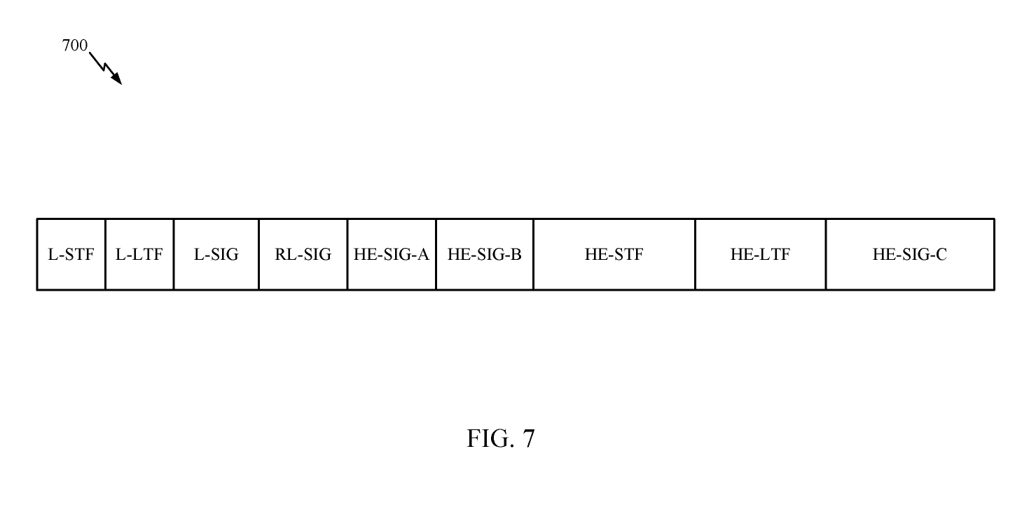

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 may be used to perform the operations described herein and illustrated with reference to FIGS. 6 and 6A. Similarly, antenna 252, Tx/Rx 254, processors 260, 270, 288, and 290, and/or controller 280 may be used to perform the operations described herein and illustrated with reference to FIGS. 7 and 7A.

FIG. 2 illustrates a block diagram of access point 110 two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

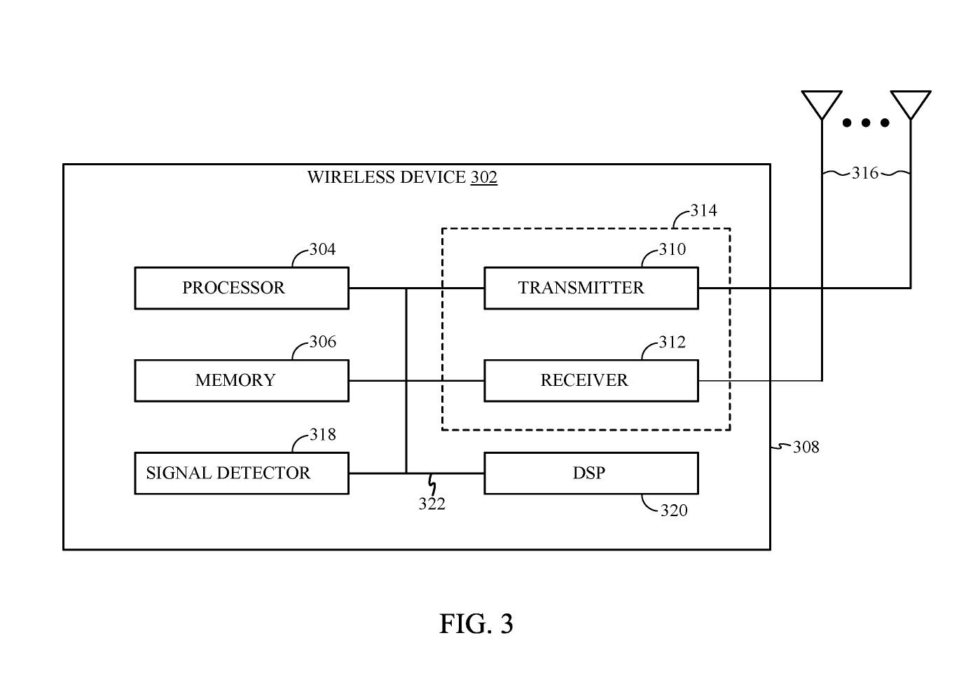

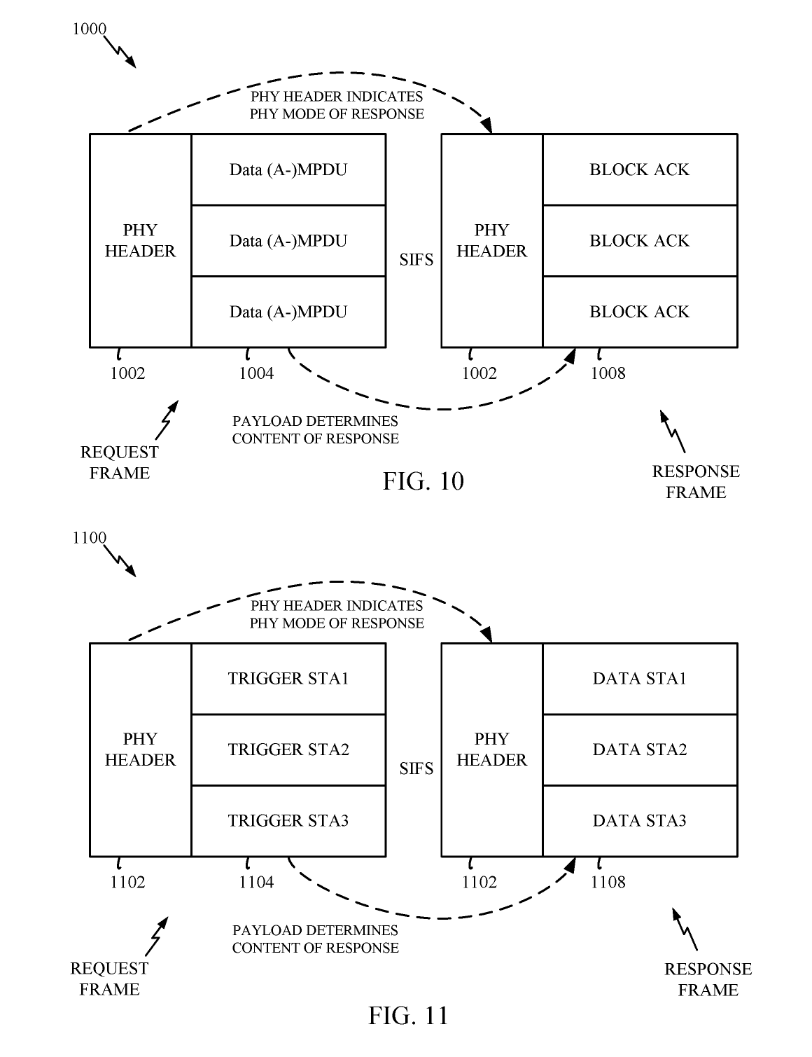

FIG. 3 illustrates various components that may be utilized in a wireless device 302 that may be employed within the MIMO system 100. The wireless device 302 is an example of a device that may be configured to implement the various methods described herein. For example, the wireless device may implement operations 1000 and 1100 illustrated in FIGS. 10 and 11, respectively. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Immediate Response Resource Allocation with Mixed PHY and MAC Signaling

In certain systems, such as IEEE 802.11ax (also known as high efficiency wireless (HEW) or high efficiency wireless local area network (WLAN)), physical (PHY) layer and medium access control (MAC) layer signaling may be used for immediate response (e.g., for the request and the response). As noted above, an immediate response may refer to a response frame that is transmitted in response to a request frame within a defined period of time (e.g., after a short interframe space (SIFS)).

Certain MAC frames may solicit an immediate response. For example, a data frame may solicit an acknowledgment (ACK) as an immediate response (e.g., a acknowledging receipt of a single data payload or multiple data payloads). As another example, a request-to-send (RTS) frame may solicit a clear-to-send (CTS) frame as an immediate response. An immediate CTS response may lead to a requesting device accessing the medium sooner for data transmission(s).

Certain MAC frames may solicit an immediate response from more than one device. In such a case, the multiple responders can use uplink (UL) multiple user (MU) multiple-input multiple-output (MIMO) or UL orthogonal frequency division multiple access (OFDMA) techniques for transmissions. As will be described in greater detail below, the request physical layer protocol data unit (PPDU) may identify and provide transmission parameters for each of the responders.

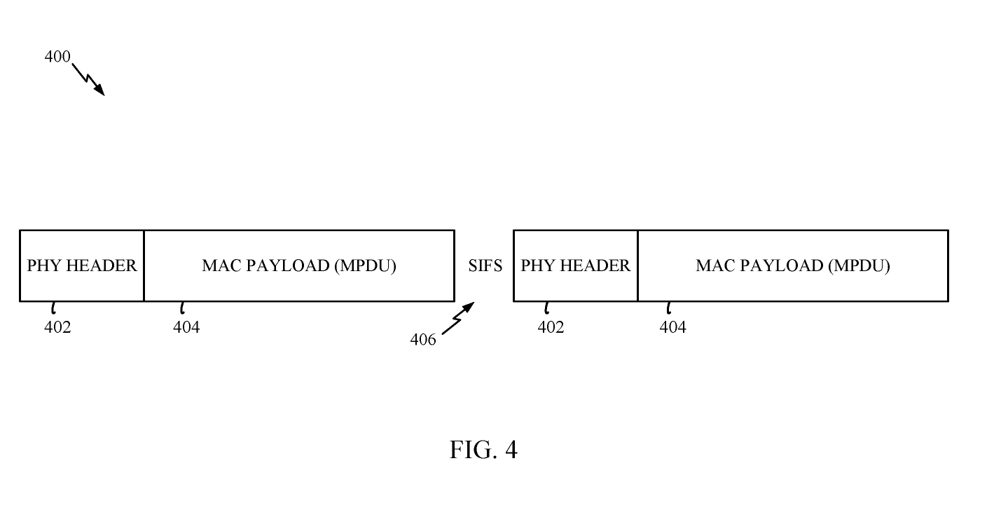

FIG. 4 illustrates an example uplink (UL)/downlink (DL) frame exchange 400 illustrating a request and an immediate response. As shown in FIG. 4, a request frame (e.g., physical layer protocol data unit (PPDU)) may have a PHY header 402 and one or more MAC payloads 404 (e.g., MAC protocol data unit (MPDU)). The request frame may solicit an immediate response. A response frame having a PHY header and a MAC payload with one or more MPDUs may be sent in response to the request frame after a SIFS period 406.

In a conventional exchange, a device (e.g., a STA) receiving the request frame may know it is solicited to respond only after decoding the MAC payload, for example, and detecting the type of request frame. Additionally, the PHY mode (e.g., generally referring to a Type, bandwidth, MCS, coding, cyclic prefix), and rate of the response may be conventionally determined based on the PHY mode of the request frame and on the MAC type of the request. Thus, the device may need to decode the entire request frame for generating or sending the response frame which, in some case, may make it difficult to respond in a time the defined period for an immediate response.

Accordingly, techniques and apparatus provided herein may enable a device to start generating or transmitting an immediate response sooner, without having to wait until after decoding an request frame.

According to certain aspects of the present disclosure, techniques and apparatus for decoupling PHY and MAC signaling, for example, by providing an early (e.g., sooner than after decoding the entire request frame) indication to the receiver than an immediate response is solicited. Such an indication may also signal parameters to use for sending the response.

According to certain aspects, PHY signaling (e.g., in the PHY header) in the request frame may define the identity of the responder (or responders), allocate the PHY resources for an immediate response from the one or more responders, and may also indicate the parameters the responders should use to form at least part of the response PPDU(s). In some cases, the immediate response PHY resource (PPDU) may carry a MAC payload that is dependent on MAC signaling from the MAC payload of the request.

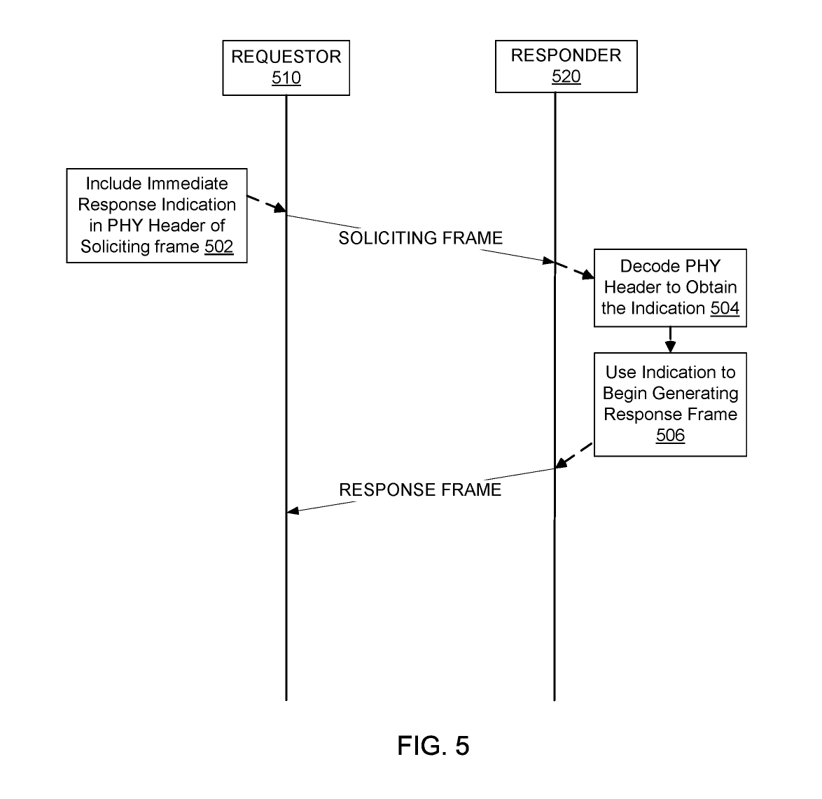

FIG. 5 is an example call flow illustrating an uplink (UL) downlink (DL) frame exchange between a requesting device (labeled as Requestor 510) and a responding device (labeled as Responder 520), in accordance with certain aspects of the present disclosure. As shown, at 502, the requestor (e.g., an AP) may include an immediate response indication in the PHY header of the soliciting (request) frame transmitted to the responder. At 504, the responder may decode the PHY header of the soliciting frame in order to obtain the indication and determine that an immediate response is requested. At 506, the responder may use the indication to begin generating a portion of the response PPDU (such as the PHY and MAC headers) prior to decoding the entire soliciting frame. In some cases, the responding device may even begin transmitting the response frame prior to completely decoding the soliciting frame.

FIG. 6 is a flow diagram of example operations 600 for generating and sending a soliciting frame, in accordance with certain aspects of the present disclosure. The operations 600 may be performed, for example, by a requestor which may be an access point (e.g., such as AP 110).

The operations 600 begin, at 602, by generating a first frame (e.g., a request PPDU) having a PHY header and a MAC payload (e.g., an MPDU or A-MPDU), with an indication provided in the PHY header of the first frame that a response frame (e.g., the response frame) to the first frame is to be sent within a time period (e.g., a SIFS period after an end of the first frame). At 604, the requestor outputs the first frame for transmission.

According to certain aspects, the indication in the PHY header of the request PPDU may explicitly identify the immediate responder(s) and the PHY mode of the response frame. For example, the indication may indicate one or more MAC address(es) of the responder(s), a MAC address of the requestor, an association identifier (AID), or some other type of (e.g., local) identifier per each of the responder(s), such as a partial MAC address, or a group identifier identifying the set of responders.

The indication may also indicate one or more parameters for transmitting the response, such as whether the response frame is to be transmitted as a single user (SU) or multiple user (MU) frame, a bandwidth for the response frame, MCS for the response frame, a guard interval (GI) for the response frame, a number of spatial streams for the response frame, or a duration of the response frame. In some cases, separate indications (with possibly different information) may be provided for each responder.

According to certain aspects, some of the response parameters may be implicitly defined by the PHY parameters of the request frame. For example, a bandwidth of the response frame may be the same bandwidth as the request frame. As another example, if the response frame is to be transmitted as SU, the duration of the response frame may be implicitly determined by the MAC payload.

Thus, the indication in the PHY header alone (e.g., without decoding the MAC payload) may be sufficient to allow the responder to begin generating, and even transmitting, the response frame. As noted above, an indication may be provided per device to which a response frame is to be allocated. According to certain aspects, if the MAC payload in the request frame needs an immediate response, then the PHY header of the first frame also allocates a response frame. Alternatively, if the MAC payload in the request frame does not need an immediate response, then the PHY header of the first frame may or may not allocate a response frame. Certain PHY parameters of the request frame and the PHY indication for the response may be set according to certain MAC information in the MAC payload of the request frame.

FIG. 7 illustrates example fields of a PHY header which may be included in the request frame, in accordance with certain aspects of the present disclosure. According to certain aspects, the indication for the immediate response may be included in one of the fields of the PHY illustrated in FIG. 7. In some cases, where to include the indication may depend on how a particular field is transmitted. For example, the indication may be included in a field having a lower coding rate, such as a high efficiency signal A (HE-SIG-A) field, or a higher coding rate field, such as an HE-SIG-B field.

The HE-SIG-A field and the HE-SIG-B field may be broadcast fields, such that in the case of MU, (one of) these fields may include an indication for all addressed devices. As an alternative, the indication may be provided in a field that is not broadcast, such as the HE-SIG-C field. The HE-SIG-C field is a per-device field and, hence, may include the indication for its recipient device only.

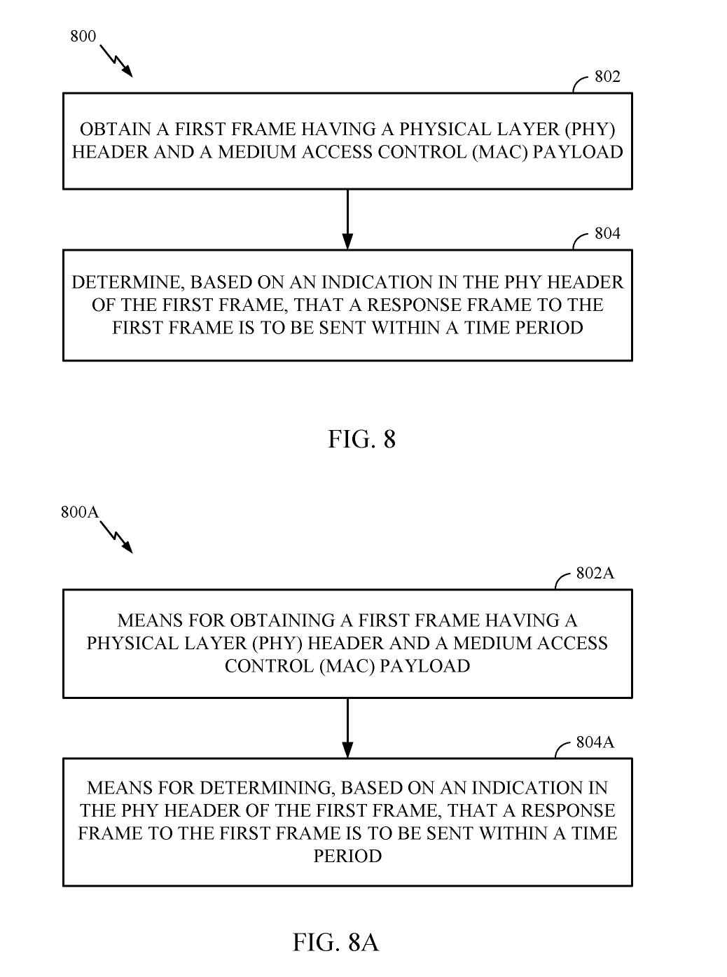

FIG. 8 is a flow diagram of example operations 800 for obtaining the soliciting frame and determining to send an immediate response based on the indication in the PHY header, in accordance with certain aspects of the present disclosure. The operations 800 may be performed, for example, by a responder device which may be a station (e.g., such as UT 120). The operations 800 may begin, at 802, by obtaining a first frame (e.g., request frame) having a PHY header and a MAC payload (e.g., an MPDU or A-MPDU).

At 804, the responder may determine, based on an indication in the PHY header of the first frame, that a response frame (e.g., the response frame) to the first frame is to be sent within a time period (e.g., a SIFS period) after an end of the first frame. For example, the responder may see that its identifier is indicated in a request frame and that it is to send an immediate response.

According to certain aspects, the response frame may act as a container for whatever MAC payload (e.g., MAC frame) is to be included in the response. For example, the MAC payload in the response frame may be an immediate response to the MAC payload in the request frame. Alternatively, the MAC payload in the response frame may be a pre-determined frame (e.g., an MC frame), which may be based on other prior signaling and/or scheduling and is not dependent on the MAC payload in the request frame.

According to certain aspects, once the responder has decoded the PHY header and determined that a response frame is solicited, the responder may begin generating at least a portion of the response frame. For example, the responder may begin to generate (and in some cases begin to transmit) the PHY header and/or the MAC header of the response frame. According to certain aspects, the responder may begin the generating and transmitting before it has decoded the MAC payload of the request PPDU.

Once the responder decodes the MAC payload, the responder may determine the content for the MAC payload (e.g., data, ACK, block ACK (BA), CTS) of the response frame. Alternatively, as mentioned above, the content of the response frame may be predetermined, for example, based on prior signaling, and may not be based on the MAC payload of the request frame at all.

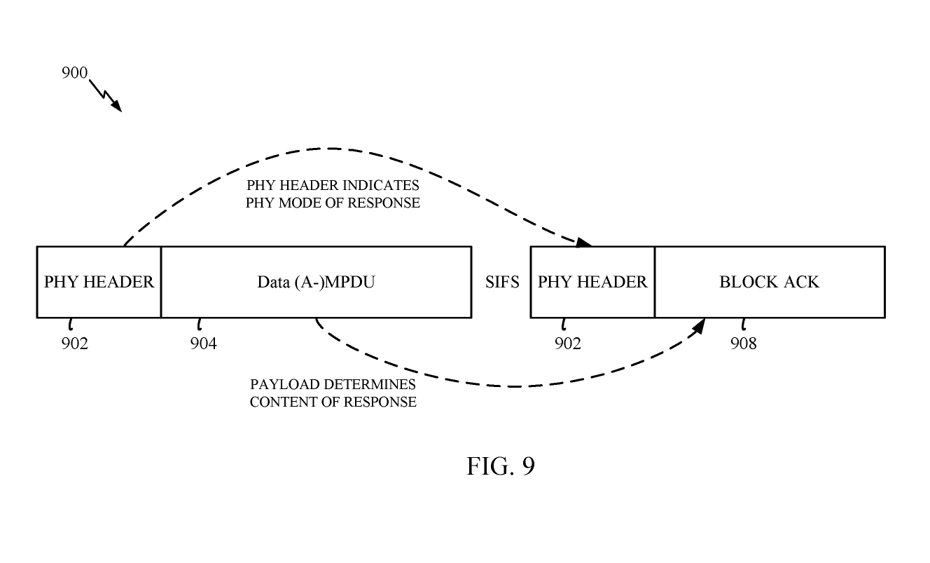

FIG. 9 illustrates an example UL/DL SU frame exchange 900, in accordance with certain aspects of the present disclosure. As shown in FIG. 9, the request frame may include a PHY header 902 and a data MPDU 904 (or A-MPDU) that needs an immediate block acknowledgement (BA) 908.

As noted above, the PHY header may indicate the identity of the responder and parameters to use for the response. The responder may decode the PHY header and determine that it a response is solicited as well as the PHY mode for the response based on the indication in the PHY header. Thus, the responder may begin generating (and transmitting) the PHY header of the response frame. Once the responder decodes the data in the MPDU of the request frame, the responder may generate and transmit the BA in the MAC payload of the response frame.

FIG. 10 illustrates another example UL/DL MU frame exchange 1000, in accordance with certain aspects of the present disclosure. According to certain aspects, a request PPDU may use DL MU multiple-input multiple-output (MIMO) or DL orthogonal frequency division multiple access (OFDMA) and the response frame may use UL OFDMA or UL MU MIMIO. As shown in FIG. 10, the request frame may include a PHY header 1002 and a data aggregated MPDU (A-MPDU) 1004 having MPDUs per-device, that each need an immediate BA from the addressed devices. The PHY header 1002 may indicate the identity of the responder devices and parameters to use for the response.

According to certain aspects, the responding devices may be different (e.g., in identity and number) than the recipient devices of the request frame. The responder devices may decode the PHY header and determine that an immediate response is solicited as well as the PHY mode for the response based on the indication in the PHY header 1002 of the request frame. Thus, the responder devices may begin generating (and transmitting) the PHY header 1002 of the response frame(s). Once the responder devices decode the data in the A-MPDU 1004 of the request frame, the responder devices may generate and transmit the corresponding BA 1008 in the MAC payload of the response frame.

As illustrated in FIG. 11, a request frame may carry one or more MAC Trigger frames 1104 for one or more devices, each soliciting an immediate response from one the solicited devices. Information regarding the immediate response may be indicated in the PHY header 1102 of the request frame. In this case, the responder stations may begin generating (and transmitting) the PHY header 1102 of the (SU, UL MU MIMO/OFDMA) response frames and, once the responder devices decode the information in the Trigger Frames 1104, may generate and transmit the corresponding MAC payload (e.g., data) 1108 of the response frames. The trigger frame 1104 may indicate the type of the MAC payload, such as Data, management, control, or allow responders to send any frame.

Applying the techniques discussed above to include signaling regarding an immediate response in the PHY header of a request frame may provide an early indication to the responder. This early indication may allow the responder to begin generating and transmitting an immediate response to the request frame before having decoded the entire request frame. As a result, the responder may be able to generate and transmit an immediate response sooner than if it had to wait to decode the entire request frame before beginning the response. Thus, this approach may improve the ability of the responder to provide the immediate response within a defined immediate response time period.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 600 illustrated in FIG. 6 and operations 800 illustrated in FIG. 8 correspond to means 600A illustrated in FIG. 6A and means 800A illustrated in FIG. 8A, respectively.

For example, means for receiving may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for obtaining, means for including, means for determining, and means for outputting may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

According to certain aspects, such means may be implemented by processing systems configured to perform the corresponding functions by implementing various algorithms (e.g., in hardware or by executing software instructions) described above for providing an immediate response indication in a PHY header. For example, an algorithm for generating a first frame having a PHY header and a MAC payload, an algorithm for providing an indication in the PHY header of the first frame, that a response frame to the first frame is to be sent within a time period, and an algorithm for outputting the first frame for transmission. In another example, an algorithm for obtaining a first frame having a PHY header and a MAC payload and an algorithm for determining, based on an indication provided in the PHY header of the first frame, that a response frame to the first frame is to be sent within a time period.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for generating a first frame having a PHY header and a MAC payload, instructions for providing an indication in the PHY header of the first frame, that a response frame to the first frame is to be sent within a time period, and instructions for outputting the first frame for transmission. In another example, instructions for obtaining a first frame having a PHY header and a MAC payload and instructions for determining, based on an indication provided in the PHY header of the first frame, that a response frame to the first frame is to be sent within a time period.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a first interface configured to obtain a first frame having a physical layer (PHY) header and a medium access control (MAC) payload; and
a processing system configured to determine, based on an indication provided in the PHY header of the first frame, that a response frame to the first frame is to be sent within a time period.

2. The apparatus of claim 1, wherein:
the processing system is configured to generate the response frame based on the determination; and
the apparatus further comprises a second interface configured to output the response frame for transmission within the time period.

3. The apparatus of claim 1, wherein the processing system is configured to determine one or more PHY transmission parameters and modes for the response frame, based on one or more PHY transmission parameters and modes used for the first frame.

4. The apparatus of claim 1, wherein the processing system is configured to determine a bandwidth for the response frame, based on a bandwidth used for the first frame.

5. The apparatus of claim 1, wherein the processing system is configured to:
decode the MAC payload of the first frame;
determine MAC content for the response frame based on the decoded MAC payload of the first frame; and
generate the response frame having the determined MAC content therein.

6. The apparatus of claim 5, wherein:
the processing system is configured to generate at least a first portion of the response frame prior to completion of decoding the MAC payload.

7. The apparatus of claim 6, wherein the first portion comprises at least a PHY header of the response frame.

8. The apparatus of claim 1, wherein the response frame comprises one of: a data frame, an acknowledgment (ACK) frame, a block ACK (BA) frame, or a clear-to-send (CTS) frame.

9. The apparatus of claim 1, wherein the indication provided in the PHY header of the first frame comprises: a MAC address of the apparatus, a partial MAC address of the apparatus, an association identifier (AID) of the apparatus, or a MAC address of a source of the first frame.

10. An apparatus for wireless communications, comprising:
a processing system configured to generate a first frame having a physical layer (PHY) header and a medium access control (MAC) payload and to provide an indication in the PHY header of the first frame, that a response frame to the first frame is to be sent within a time period; and
a first interface configured to output the first frame for transmission.

11. The apparatus of claim 10, wherein the MAC payload comprises one of: a MAC protocol data unit (MPDU), an aggregated MPDU (A-MPDU), or a request-to-send (RTS) frame.

12. The apparatus of claim 10, wherein the indication provided in the PHY header of the first frame comprises at least one of: a MAC address of one or more devices, a partial MAC address of the one or more devices, an association identifier (AID) of the one or more devices, or a MAC address of the apparatus.

13. The apparatus of claim 10, wherein the indication provided in the PHY header of the first frame comprises one or more PHY transmission parameters and modes for the response frame.

14. The apparatus of claim 13, wherein the one or more PHY transmission parameters comprise at least one of: an indication of whether the response frame is to be transmitted as a single user (SU) or multiple user (MU) frame, a bandwidth for the response frame, a modulation and coding scheme (MCS) for the response frame, a guard interval (GI) for the response frame, a number of spatial streams for the response frame, or a duration of the response frame.

15. The apparatus of claim 10, wherein the indication is provided via a broadcast field of the PHY header of the first frame.

16. A method for wireless communications, comprising:
obtaining a first frame having a physical layer (PHY) header and a medium access control (MAC) payload; and
determining, based on an indication provided in the PHY header of the first frame, that a response frame to the first frame is to be sent within a time period.

17. The method of claim 16, further comprising:
generating the response frame based on the determination; and
outputting the response frame for transmission within the time period.

18. The method of claim 16, further comprising determining one or more PHY transmission parameters and modes for the response frame, based on one or more PHY transmission parameters and modes used for the first frame.

19. The method of claim 16, further comprising determining a bandwidth for the response frame, based on a bandwidth used for the first frame.

20. The method of claim 16, further comprising:
decoding the MAC payload of the first frame;
determining MAC content for the response frame based on the decoded MAC payload of the first frame; and
generating the response frame having the determined MAC content therein.

21. The method of claim 20, wherein:
at least a first portion of the response frame is generated prior to completion of decoding the MAC payload.

22. The method of claim 21, wherein the first portion comprises at least a PHY header of the response frame.

23. The method of claim 16, wherein the response frame comprises one of: a data frame, an acknowledgment (ACK) frame, a block ACK (BA) frame, or a clear-to-send (CTS) frame.

24. The method of claim 16, wherein the indication provided in the PHY header of the first frame comprises: a MAC address of the apparatus, a partial MAC address of the apparatus, an association identifier (AID) of the apparatus, or a MAC address of a source of the first frame.

25. A method for wireless communications, comprising:
generating a first frame having a physical layer (PHY) header and a medium access control (MAC) payload;
providing an indication in the PHY header of the first frame, that a response frame to the first frame is to be sent within a time period; and
outputting the first frame for transmission.

26. The method of claim 25, wherein the MAC payload comprises one of: a MAC protocol data unit (MPDU), an aggregated MPDU (A-MPDU), or a request-to-send (RTS) frame.

27. The method of claim 25, wherein the indication provided in the PHY header of the first frame comprises at least one of: a MAC address of one or more devices, a partial MAC address of the one or more devices, an association identifier (AID) of the one or more devices, or a MAC address of the apparatus.

28. The method of claim 25 wherein the indication provided in the PHY header of the first frame comprises one or more PHY transmission parameters and modes for the response frame.

29. The method of claim 28, wherein the one or more PHY transmission parameters comprise at least one of: an indication of whether the response frame is to be transmitted as a single user (SU) or multiple user (MU) frame, a bandwidth for the response frame, a modulation and coding scheme (MCS) for the response frame, a guard interval (GI) for the response frame, a number of spatial streams for the response frame, or a duration of the response frame.

30. The method of claim 25, wherein the indication is provided via a broadcast field of the PHY header of the first frame.

31-49. (canceled)
